(19) United States
(12) Patent Application Publication
(10) Pub. No.: US 2004/0068916 A1
(43) Pub. Date: Apr. 15, 2004

(54) Fish scent dispenser

(76) Inventor: Darrell Harris, Oregon City, OR (US)

Correspondence Address: Michael W. Starkweather, Jones, Waldo, Holbrook & McDonough, Suite 1500, 170 South Main Street, Salt Lake City, UT, 84101, US

(21) Appl. No.: 10/272,145

(22) Filed: Oct. 15, 2002

(51) Int. Cl. A01K 97/02

(52) U.S. Cl. 43/44.99

(57) ABSTRACT

A fish scent dispenser, for attaching on a fishing line and dispensing fish attractant scent into water, comprising: a) an upper housing and a lower housing, the upper and lower housings abutting to each other to form both a cavity therein and a housing longitudinal axis therethrough; b) a fish scent material, located in the cavity, that is slowly dissolved in the water as the fish scent dispenser is pulled through the water; c) attaching means for attaching the fish scent dispenser to the fishing line; and d) rotating means, coupled to the fish scent dispenser, for rotating the fish scent dispenser about the longitudinal axis. It is more particularly claimed as features of the invention to provide the rotating means that may be a fin designed to cause the housing to rotate when water is forced over the upper and lower housing along a direction parallel to the longitudinal axis. The invention may further comprise a shaft extending through the upper and lower housing along the longitudinal axis. Wherein the attaching means may be a ring attached to either end of the shaft so that the fishing line may be attached to at least one ring. Wherein the attaching means may be an upper and lower hole located in the upper and lower housing respectively that are positioned along the longitudinal axis to therefore allow a fishing line to be threaded therethrough each hole.

### FIELD OF THE INVENTION

This invention relates to fishing lure equipment. More particularly, there is a fish scent dispenser device to distribute scent that attracts fish to the proximity of the fisherman and specifically toward a fishing lure being used by the fisherman.

### BACKGROUND

Recreational or sport fishing has constantly been increasing in popularity. One of the most exciting and popular varieties of sport fishing involves so-called trolling type fishing, in which a number of lines and lures may be pulled behind and to the side of a fishing boat as the boat moves over the open ocean or lake. The variety of lures available to sport fisherman is legendary. Some lures have been designed to attract fish by virtue of arresting and attractive color schemes. Other lures attract fish because, when the lures are drawn behind the boat, the lures undergo an oscillatory pitching or rolling motion. Still other lures are designed to dispense chum or scent meant to attract fish. The practice of chumming involves the dispensation of various fluids or small particulate matter having a particular odor attractive to the fish sought to be caught by the fishermen. If chum is spread in the water by a lure or near a lure, fish are more likely to be attracted and caught.

However, many fish scent dispensing devices are not optimized to increase fish scent dispersal. Water does not flow easily into and out of the dispenser. It is often difficult to replace the fish scent in the dispenser. The dispensers do have sound attracting means built therein.

### SUMMARY OF THE INVENTION

It is a feature of the invention to produce a fishing scent dispenser to distribute scent that attracts fish to the proximity of the fisherman and specifically toward a fishing lure being used by the fisherman.

It is yet a further feature of the present invention to provide fish scent dispensing device that may optimized to increase fish scent dispersal, that may allow water to flow easily into and out of the dispenser; that easily allows the replacement of the fish scent in the dispenser; and may have sound attracting means built therein.

It is yet another feature of the invention to produce a fishing lure that releases a fish attracting substance over an extended period of time.

It is still another feature of the invention to produce a fishing lure that is economical to manufacture, and easy to use.

It is a further feature of the invention to produce a fishing lure that attaches to a fishing line near a fishing lure location.

It is a still further feature of the invention to produce a fishing lure that may selectively slide freely along a fishing line, or may be designed to maintain a fixed position along the fishing line.

It is more particularly claimed as features of the invention to provide: a fish scent dispenser, for attaching on a fishing line and dispensing fish attractant scent into water, comprising: a) an upper housing and a lower housing, the upper and lower housings abutting to each other to form both a cavity therein and a housing longitudinal axis therethrough; b) a fish scent material, located in the cavity, that is slowly dissolved in the water as the fish scent dispenser is pulled through the water; c) attaching means for attaching the fish scent dispenser to the fishing line; and d) rotating means, coupled to the fish scent dispenser, for rotating the fish scent dispenser about the longitudinal axis.

It is more particularly claimed as features of the invention to provide the rotating means that may be a fin designed to cause the housing to rotate when water is forced over the upper and lower housing along a direction parallel to the longitudinal axis. The invention may further comprise a shaft extending through the upper and lower housing along the longitudinal axis. Wherein the attaching means may be a ring attached to either end of the shaft so that the fishing line may be attached to at least one ring. Wherein the attaching means may be an upper and lower hole located in the upper and lower housing respectively that are positioned along the longitudinal axis to therefore allow a fishing line to be threaded therethrough each hole.

It is more particularly claimed as features of the invention may be to provide the rotating means as at least two fins located on the upper housing. Wherein the rotating means may be at least two fins, one located on the upper housing and the other located on the lower housing.

It is more particularly claimed as features of the invention to provide an upper and lower hole, located on the upper and lower housing respectively, both holes formed to have an entrance and exit opening and a bore connecting the entrance and exit openings, the bore having a bore longitudinal axis that is parallel to the housing longitudinal axis. Wherein the upper and lower housings may also have a plurality of holes formed thereon.

It is more particularly claimed as features of the invention to provide a resilient device that may be located between one ring and the lower housing to cause the fish scent dispenser to bounce along the shaft as the fish scent dispenser is pulled through the water.

It is more particularly claimed as features of the invention to provide the fish scent material that may be a sponge-type material that is impregnated with fish scent liquid. Wherein the fish scent material may be a fish scent solid form.

It is more particularly claimed as features of the invention to provide a sound producing means, located in the cavity. Wherein the sound producing means may be a bead positioned within the cavity.

There has thus been outlined, rather broadly, the more important features of the invention so that the detailed description thereof that follows may be better understood, and so that the present contribution to the art may be better appreciated. Other features of the present invention will become clearer from the following detailed description of the illustrated invention, taken with the accompanying drawings and claims, or may be learned by the practice of the invention.

### BRIEF DESCRIPTION OF THE DRAWINGS

The present invention will be understood more fully from the detailed description given below in conjunction with the accompanying drawings of the illustrated embodiment of the invention, which, however, should not be taken to limit the invention, but are for explanation and understanding only.

FIG. 1, is an isometric drawing of a fish scent dispenser.

FIG. 2 is a cross sectional drawing of the fish scent dispenser of FIG. 1.

FIG. 3 is a cross sectional drawing of a representative design of a hole positioning found in FIGS. 1 and 2.

It is noted that the drawings of the invention are merely schematic representations, not intended to portray specific parameters of the invention. The drawings are intended to depict only typical embodiments of the invention, and therefore should not be considered as limiting the scope of the invention. The invention will be described with additional specificity and detail through the accompanying drawings. Additionally, like numbering in the various drawings represent like elements within and between the drawings.

### GENERAL DEFINITIONS

By way of background information, it is assumed that one skilled in the art is an engineer familiar with the art of fishing and fishing lure design, fabrication and implementation.

As used herein, and by way of illustration only, the fish scent material utilized in the present invention may be in the form of either solidified or deformable fish attractant material or a liquid applied to a porous material, like a sponge material, which is adapted to absorbedly receive commercially available fish attractant liquid or paste to be repeatedly impregnated therein.

Although the above supplied definitions are provided, they are not limiting in scope of the invention, but are merely provided to assist the reader in an initial reading of the invention. One skilled in the art will realize that there are more meanings and definitions to these and other words used herein, which are not detailed above for brevity purposes.

### DETAILED DESCRIPTION OF THE ILLUSTRATED EMBODIMENT(S)

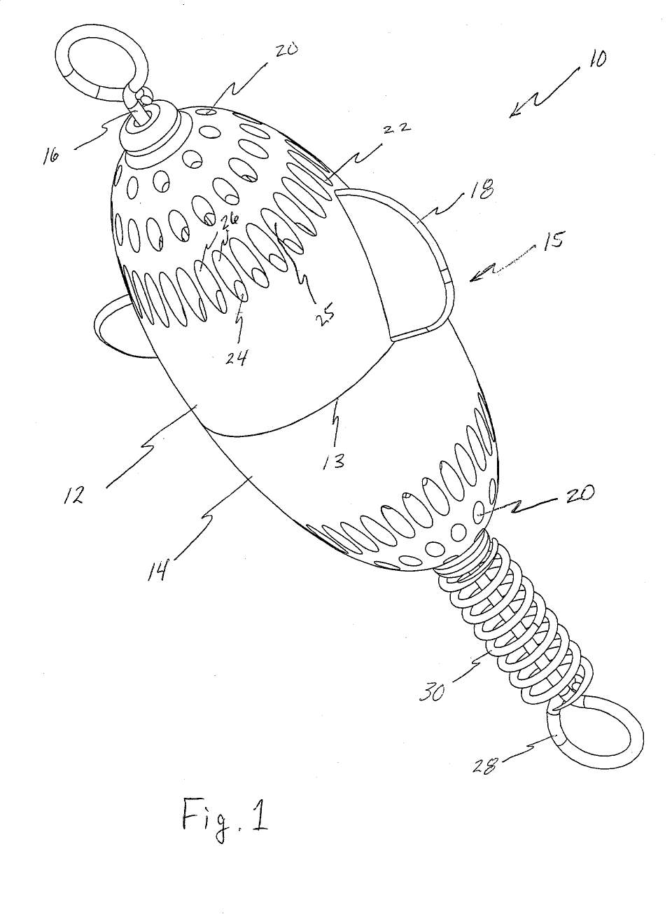

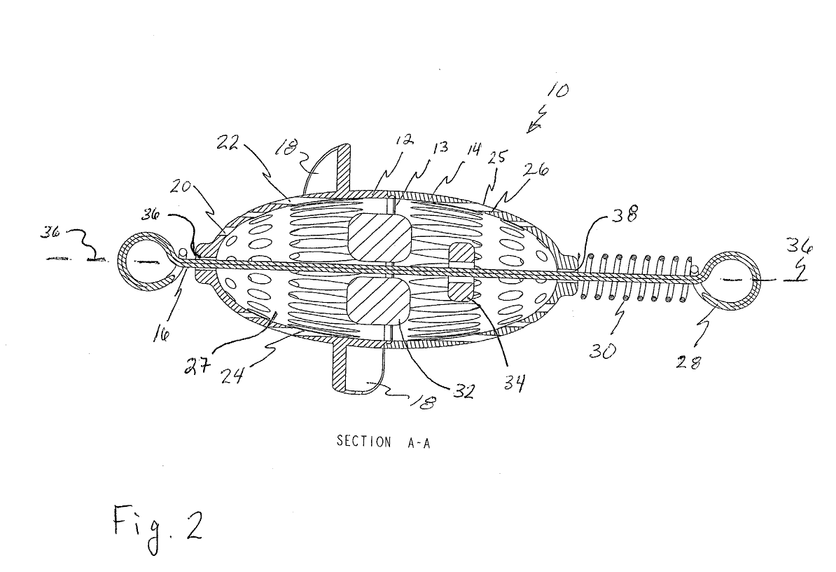

Referring to FIGS. 1, 2 and 3, there is illustrated only a representative embodiment of the illustrated embodiment. Specifically, there is a fish scent dispenser 10, having a top half of a housing 12 and a bottom half 14, which are separated by a dividing line 13, these parts making up a whole dispenser housing 15. The top half and bottom half housings may also be referred to as an upper and lower housing.

There is a central shaft 16, which is optionally provided, as the invention will work without this shaft 16 in another embodiment described below. There is at least one fin 18, but preferably two or more, which are shaped and designed to act like a propeller on a boat engine or plane propeller prop.

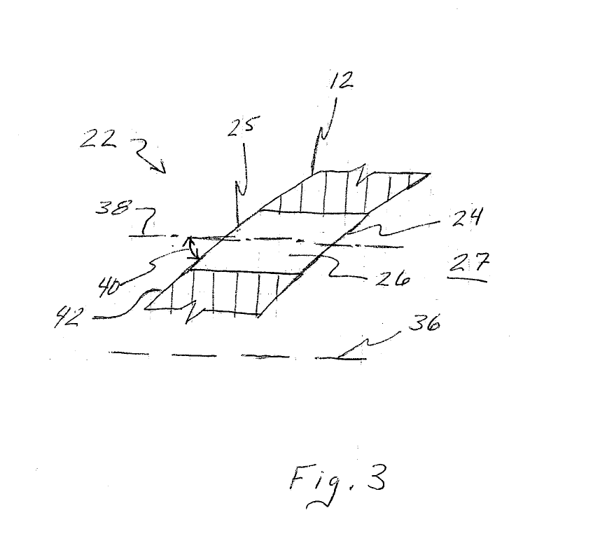

There is at least one hole 20 in each of the two portions 12 and 14 of the housing 15. Uniquely, and in reference to hole 22, all the holes located on the dispenser 10 are formed through the housing wall to be oriented substantially with a bore 26 to be parallel to the shaft 16. In this fashion, the hole 22 has an exit opening 24 that is spaced away from an entrance opening 25, which are separated by the elongated bore 26 that has a longitudinal axis 38 extending through the bore. The bore longitudinal axis being parallel to the longitudinal axis 36 extending along the shaft. Specifically, as illustrated in FIG. 3 the bore longitudinal axis 38 forms an angle 40 to the surface of the upper housing 12 because the hole illustrated is located away from the location of the shaft 16.

Attached to either end of the shaft 16 is a fishing line attachment feature 28, illustrated as a ring. At one end of the dispenser 10, and positioned about the shaft 16, is an optional biasing device 30, illustrated as a spring. Within cavity 27, there is also a fish scent retainer material 32, illustrated as a round donut shaped sponge material, which may be positioned along the shaft 16. An optional sound producing device 34, illustrated as a donut shaped bead, may also be positioned along the shaft 16.

### OPERATION OF THE ILLUSTRATED EMBODIMENT(S)

One skilled in the art will easily understand, after reviewing the described invention, that operation of the invention is straight forward. In particular, the ring 28 on either end of the dispenser 10 are meant to be attached to the fishing line (not shown). There are several ways to attach the dispenser to the line, but one way may be to split the fishing line and joining the two ends of the split line to either end of the shaft, and in particular to the rings 28.

If motion of the dispenser 10 is through the water along a line of action parallel to the shaft 16, the whole dispenser housing 15 will rotate in a known fashion about the shaft 16 due to the design of the fins 18 and due to the fact that the housing 15 is rotatably and loosely mounted to the shaft 16. This has the added benefit of causing the fish scent to be dispersed in a swirling fashion through the water, adding to the mixing thereof and easier fish attracting characteristics. This also has the benefit of shaking or disturbing the fish scent located inside the dispenser, thus again aiding in increasing the dispersal of the scent through the water thereof.

The motion of the dispenser 10 through the water, and in particular reference to the holes 20 and 22 arrangements, causes water to enter into the top housing half 12 and enter into the cavity 27, thereby being mixed or disturbing the scent holding material 32 and exit through holes 20 and 22 in the bottom half 14. The rotation of the housing 15 has the benefit of increasing the mixing of the water with the scent within the cavity 27, and thereby removing larger amounts of the scent. Also, the parallel nature of the bore 26 enables more direct force to be applied by the entering water to impact on the scent material 32.

The optional spring 30 may have several purposes, one may be to hold the top and bottom housing sections 12 and 14 together when in operation as a result of the biasing force applied to between the bottom housing 14 and the respective ring 28. Another purpose of the spring 30 may be to allow for easy separation of the two portions 12 and 14. Specifically, by applying force to the bottom housing 14 toward the bottom ring 28, the bottom housing 14 can be separated from the top housing 12, which enables a user to place more fish scent into the cavity 27. Yet, a further feature of the spring is to allow the whole housing 15 to be bounced along shaft 16 when the dispenser 10 is jerked through the water. Of course, the spring tension, size or materia property of “modulis of elasticity” would be a controlling factor to the degree of “springiness” that would occur in the operation of the dispenser 10.

The sound producing device 34, illustrated as a bead, may be designed to slide along the shaft 16. When the bead hits the housing 15 it will create a clicking sound. The device 34 may also act to further extract more scent from the retaining material 32 when it hits that material.

The scent retainer 32 is designed to be mounted along the shaft 16. This can be accomplished either to allow for free motion along the length of the shaft 16, or be fixed tight in a set location along the shaft 16. A longitudinal axis 36 is coextensive to the shaft 16 as illustrated, which is the axis about which the housing 15 rotates. In operation, a liquid scent would be deposited on to the retainer material 32 after opening the two halves of the housing 15.

In further regards to FIG. 3, there is further illustrated the design of a hole 22 that is positioned a distance away from the housing longitudinal axis 36. In particular, there is the entrance opening 25, the exit opening 24, the bore 26 and bore longitudinal axis 38, and an angle 40 formed between the housing surface 42 and the bore longitudinal axis 38. Both longitudinal axis 36 and 38 are parallel to each other, and coextensive to the line of motion of the dispenser 10 as it travels through the water. It is noted that the angle 40 is not perpendicular to the surface 42, which would be the case if most other scent dispensers that are not concerned with efficient water motion into the cavity 27. The angle exists to allow the water to enter in a straight fashion that is parallel to the line of dispenser motion through the water, thus giving more force to the water entering the cavity 27 and making the rotating motion more efficient since there is no counter forces created by poorly designed hole patterns that create more friction to the rotating motion.

### ALTERNATIVE EMBODIMENT(S)

As alluded to above, one alternative embodiment is to design the scent dispenser 10 without the use of the central shaft 16 and attached rings 28. In this design, a skilled artisan will realize that a preferred method of attaching the dispenser 10 would be to thread the fishing line through the top and bottom holes 36 and 38 respectively. In this fashion, there are many other applications available to fisherman. Of course, the operation of the fish scent retainer 32 and the bead 34 would be changed also. Specifically, the scent retainer 32 and/or the bead 34 may or may not be threaded through the fishing line, and combinations of these threading will have differing affects to the release of scent. Nonetheless, the orientation of the holes would be parallel to the fishing line in stead of the shaft 16, but the operation would obviously remain the same. It is noted that in this embodiment there would have to be another method of retaining the top and bottom housing 12 and 14 theretogether, like a screwing method or a friction fit method would suffice.

Yet, a further alternative embodiment would be to modify the fin design. For example, the fins could be eliminated altogether. The fins can change in size, like becoming even small protrusions on the surface. Any dimension changes would just need to retain the benefit of causing rotation of the housing 15. Also, fins could be on the top and bottom housing. The fins on the top and bottom housings could be placed on the top and bottom housing 12 and 14 and be oriented or shaped opposite to each other to cause counter rotation between the top and bottom housings. This will greatly increase the disturbing of the scent material located withing the cavity 27.

Variations of the Invention

In addition to the previously indicated variations, numerous other modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function, manner of operation, assembly, and use may be made without departing from the principles and concepts set forth herein.

Although, optional fishing line attachment devices may be used in stead of the rings 28, like a clip or any releasably retaining line holding device.

Scent sponge material 32 can be any type of material designed to absorb fish scent. It is also contemplated to use multiple sponges or to not use any sponge material at all. I fno sponge were to be used, then a fisherman would know to use a solid pellet of fish attracting material that is merely placed, squirted, squeezed or deposited withing the cavity of the dispenser 10. There are many types of these solid material concoctions on the market that may be placed in the cavity.

Although reference is made to the use of a bead 34, a skilled artisan will know that any device can be used that causes sound to be created from impact with the interior walls of the housing 15, like projection fingers or bells.

Again, reference is made to having two rings 28, one located at either end of the shaft 16. It is contemplated, though, to have only one ring that would be located at only one end of the shaft. This would allow for unique ways of attaching the dispenser to the fishing line. Also, closely related to this concept, is using the two ring design but only attaching the top ring to the fishing line to allow the dispenser to dangle therefrom.

Although various embodiments of the invention are shown and described herein, they are not meant to be limiting, for example, those of skill in the art may recognize certain modifications to these embodiments, which modifications are meant to be covered by the spirit and scope of the appended claims.

Additionally, although subheadings in the Detailed Description of the Illustrated Embodiment are used, they are merely provided for generally assisting the reader; wherein the patent drafter is generally free to enter any information under any heading(s).

Further, the purpose of the abstract is to enable the U.S. Patent and Trademark Office and the public generally, and especially the scientists, engineers and practitioners in the art who are not familiar with patent or legal terms or phraseology, to find out quickly from a cursory inspection the nature and essence of the technical disclosure of the application. The abstract is neither intended to define the invention of the application, which is measured by the claims, neither is it intended to be limiting as to the scope of the invention in any way.

What is claimed is:

1. A fish scent dispenser, for attaching on a fishing line and dispensing fish attractant scent into water, comprising:
a) an upper housing and a lower housing, the upper and lower housings abutting to each other to form both a cavity therein and a housing longitudinal axis therethrough;
b) a fish scent material, located in the cavity, that is slowly dissolved in the water as the fish scent dispenser is pulled through the water;
c) attaching means for attaching the fish scent dispenser to the fishing line; and
d) rotating means, coupled to the fish scent dispenser, for rotating the fish scent dispenser about the longitudinal axis.

2. The apparatus as recited in claim 1, wherein the rotating means is a fin designed to cause the housing to rotate when water is forced over the upper and lower housing along a direction parallel to the longitudinal axis.

3. The apparatus as recited in claim 2, further comprising a shaft extending through the upper and lower housing along the longitudinal axis.

4. The apparatus as recited in claim 3, wherein the attaching means is a ring attached to either end of the shaft so that the fishing line may be attached to at least one ring.

5. The apparatus as recited in claim 1, wherein the attaching means is an upper and lower hole located in the upper and lower housing respectively that are positioned along the longitudinal axis to therefore allow a fishing line to be threaded therethrough each hole.

6. The apparatus as recited in claim 1, wherein the rotating means is at least two fins located on the upper housing.

7. The apparatus as recited in claim 1, wherein the rotating means is at least two fins, one located on the upper housing and the other located on the lower housing.

8. The apparatus as recited in claim 1, further comprising an upper and lower hole, located on the upper and lower housing respectively, both holes formed to have an entrance and exit opening and a bore connecting the entrance and exit openings, the bore having a bore longitudinal axis that is parallel to the housing longitudinal axis.

9. The apparatus as recited in claim 8, wherein the upper and lower housings have a plurality of holes formed thereon.

10. The apparatus as recited in claim 4, further comprising a resilient device that is located between one ring and the lower housing to cause the fish scent dispenser to bounce along the shaft as the fish scent dispenser is pulled through the water.

11. The apparatus as recited in claim 1, wherein the fish scent material is a sponge-type material that is impregnated with fish scent liquid.

12. The apparatus as recited in claim 1, wherein the fish scent material is a fish scent solid.

13. The apparatus as recited in claim 1, further comprising a sound producing means, located in the cavity.

14. The apparatus as recited in claim 13, wherein the sound producing means is a bead positioned within the cavity.
